(19) United States
(12) Patent Application Publication
(10) Pub. No.: US 2008/0029450 A1
(43) Pub. Date: Feb. 7, 2008

(54) Valve module

(75) Inventors: Thomas Rodewaldt, Herxheim (DE); Christian Thalmann, Speyer (DE)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL GmbH, Ludwigsburg (DE)

(21) Appl. No.: 11/892,660

(22) Filed: Aug. 24, 2007

Related U.S. Application Data
(63) Continuation of application No. PCT/EP2006/060253, filed on Feb. 24, 2006.

(30) Foreign Application Priority Data
Feb. 24, 2005 (DE) 10 2005 008 923.2

(51) Int. Cl. B01D 35/02

(52) U.S. Cl. 210/340; 210/488; 210/429; 137/859

(57) ABSTRACT

A valve module for control of a fluid flow, especially flow of a fluid to be filtered in a filter apparatus. The valve module includes a valve (12) with a valve cover (14) a valve body (13) and a valve seat (15). The valve body mates with the valve seat (15), which is integrated in an adapter plate (11). The adapter plate (11) is provided with an inlet (27) and an outlet, with an unfiltered fluid channel (20) and a filtered fluid channel (22) arranged in the adapter plate. The integration of the valve seat (15) and unfiltered and filtered fluid channels (20, 22) in the adapter plate (11) makes possible a space-saving construction of the valve (12).

### CROSS REFERENCE TO RELATED APPLICATIONS

This application is a continuation of international patent application no. PCT/EP2006/060253, filed Feb. 24, 2006 designating the United States of America and published in German on Aug. 31, 2006 as WO 2006/089945, the entire disclosure of which is incorporated herein by reference. Priority is claimed based on Federal Republic of Germany patent application no. DE 10 2005 008 923.2, filed Feb. 24, 2005.

### BACKGROUND OF THE INVENTION

The present invention relates to a valve module and to a filter device incorporating such a valve module.

Diaphragm valves, which are intended to control a fluid flow, are known. An example of diaphragm valves of this type is shown in FIG. 5. The following reference numerals relate to this figure. The diaphragm valve has a valve housing 101, to which a diaphragm 103 is attached. A valve housing cover 102 is situated above the diaphragm 103, which is connected to the diaphragm 103 to form a seal. An inlet 104 and an outlet 105 are situated in the valve housing 101, the inlet 104 being separated from the outlet 105 by the diaphragm 103 to form a seal below a predefined pressure level. When the predefined pressure level is exceeded, the diaphragm 103 lifts off of a valve seat 106 situated on the valve housing 101. The fluid may thus flow from the inlet 104 to the outlet 105. The diaphragm valve is connected to fluid lines, which supply the fluid to the diaphragm valve and drain it therefrom. This diaphragm valve requires a relatively large amount of space, because the fluid is conducted through the valve housing 101.

### SUMMARY OF THE INVENTION

The object of the present invention is to provide an improved diaphragm valve module.

Another object of the invention is to provide a valve module which requires less overall space than prior designs.

A further object of the invention is to provide a valve module which is cost-effective.

These and other objects are achieved in accordance with the present invention by providing a valve module for controlling a fluid flow comprising a valve having a valve cover, a valve body, and a valve seat, in which the valve body is configured to matingly correspond to the valve seat; the valve seat is integrated in an adapter plate; the valve body and the valve cover are attached to the adapter plate in a sealed manner to form a control chamber; and the adapter plate has an unfiltered fluid channel and a filtered fluid channel situated inside the adapter plate, an inlet leading to the unfiltered fluid channel, and an outlet leading from the filtered fluid channel.

The valve module according to the present invention is used for controlling a fluid flow, in particular a liquid flow to be filtered. The valve module comprises a valve having a valve cover, a valve body, and a valve seat. The valve body matingly engages the valve seat, which advantageously may be integrated in an adapter plate. The valve body and the valve cover are connected to the adapter plate, the adapter plate having an inlet and an outlet. An unfiltered fluid channel and a filtered fluid channel are situated inside the adapter plate. The valve body may have any desired configuration, e.g., as a ball or plate. Because the adapter plate forms the valve seat, a valve bottom part may be omitted. Overall space is thus saved on one hand, and guidance of the flow is simplified on the other hand, because the fluid flow is guided in the adapter plate in any case.

In accordance with one advantageous embodiment of the invention, the valve seat is press-fit into the adapter plate. If desired, a different material may be selected for the valve seat than for the adapter plate. Furthermore, the valve seat may be machined on different machines than the adapter plate.

In another advantageous embodiment of the invention, the valve body is a resilient or elastic diaphragm. It may comprise different areas. Preferably, the diaphragm has a boundary zone which is connected to the adapter plate, by which exact positioning of the diaphragm is achieved and slipping is prevented.

It is advantageous if the adapter plate is provided with a valve in the area of the filtered fluid channel, with which the filtered fluid channel can be closed. The filtered fluid channel may thus be closed or opened as needed. This is advantageous when replacing attachment parts.

In accordance with a further advantageous embodiment of the present invention, the adapter plate is provided with a valve in the area of the unfiltered fluid channel, with which the unfiltered fluid channel can be closed. Therefore, downstream components may be changed without any undesired discharge of fluid from the overall device.

In one refinement of the present invention, the filtered fluid channel is provided with at least two valves arranged in parallel, which close or open two separate channels independently of one another. Therefore, only one single channel or all channels may have flow through them as needed. This is especially significant for the flow through components situated downstream.

The filter device according to the present invention is used for filtering a fluid, in particular a processing fluid. Processing fluids in the sense of the present patent application include gases or liquids which are used, for example, to carry away chips or cuttings created during the machining of workpieces or the production of products. For example, the processing fluid may be an air stream or a coolant and/or lubricant, which carry away severed material from the workpiece and/or protect the tool. The filter device comprises a valve module as described above, a container, an unfiltered fluid connection, and a filtered fluid connection. At least one filter unit stack is arranged in the container and is connected to the valve module. The valves serve to individually activate or actuate the filter unit stacks.

### BRIEF DESCRIPTION OF THE DRAWINGS

The invention will be described in further detail hereinafter with reference to illustrative preferred embodiments shown in the accompanying drawing figures, in which:

FIG. 1 is a side elevation view of a filter device according to the present invention;

FIG. 1a is a schematic view of a filter device according to the invention;

FIG. 2 is a sectional view of an adapter plate for the valve of the invention;

FIG. 3 is a sectional view of a valve in the filtered fluid channel taken along line A-A of FIG. 2;

FIG. 4 is a sectional view of a valve in the unfiltered fluid channel taken along line B-B of FIG. 2, and

FIG. 5 is a sectional view of a prior art diaphragm valve.

### DETAILED DESCRIPTION OF PREFERRED EMBODIMENTS

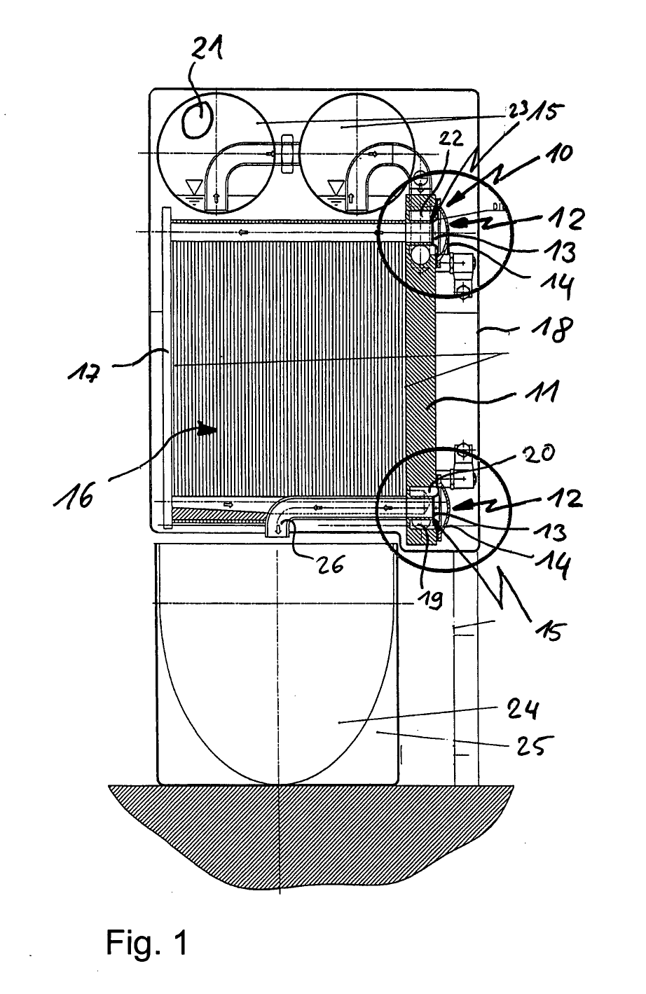

A filter device is schematically illustrated in FIG. 1. The filter device comprises a valve module 10, which is formed by an adapter plate 11 and valves 12. The valves 12 each comprise a flexible elastic diaphragm 13 and a valve cover 14. The diaphragm 13 and the valve cover 14 are attached to the adapter plate 11. The diaphragm 13 contacts a valve seat 15, which is integrated into the adapter plate, e.g., by constructing it in one piece with the adapter plate or by press-fitting it into the adapter plate. A filter unit stack 16, which is composed of individual filter units as are known in the prior art, adjoins the adapter plate 11. Multiple filter unit stacks 16 may also be arranged in parallel to increase the filter area. These multiple filter units produce a filter unit module 16a. The filter units each comprise a filter medium, an unfiltered fluid channel, and a filtered fluid channel. The filter unit stack 16 is closed on the side situated opposite the adapter plate 11 by a clamping plate 17. The entire unit composed of the valve module 10, the filter unit stack 16, and the clamping plate 17 is situated in a vessel or container 18. The unfiltered fluid connection 19 opens into an unfiltered fluid channel 20 in the adapter plate 11. The fluid to be filtered may be introduced into the filter device through the unfiltered fluid connection 19. Furthermore, the adapter plate 11 comprises a filtered fluid channel 22, which is connected to a collecting vessel 23. The filtered fluid is discharged from the filter device. A part of the fluid is stored in the collecting vessel 23 until it is needed to backwash the filter units. A filtered fluid connection 21, through which the fluid may be drawn out, may be provided for removing the filtered fluid. However, as an alternative, the collecting container 23 also may be exchanged when full.

A filter bag 24, which is situated in a drawer 25, is situated below the container 18. A concentrate drain 26, which is closable by the valve 12 disposed in the unfiltered fluid channel 20, discharges into the filter bag 24.

The fluid to be filtered flows through the unfiltered fluid connection 20 into the adapter plate 11. The valve 12 in the unfiltered fluid channel 20 is closed, as a result of which the fluid flows through the filter unit stack 16. The valves 12 in the filtered fluid channel 22 are opened, so that the filtered fluid flows through the filtered fluid channel 22 into the collecting vessel 23.

After a defined time interval, and/or as needed, the filter units of the filter unit stack 16 may be regenerated. For this purpose, the valve 12 in the filtered fluid channel 22 of the filter unit stack 16 which is to be cleaned is opened, and the valves 12 of the filter unit stacks 16 which are not to be regenerated are closed. The valve 12 in the unfiltered fluid channel 20 is opened. The filtered fluid impinges against the filter units and flows back through them in the opposite flow direction. The deposits on the inflow side of the filter unit are thus removed and flushed through the concentrate drain into the filter bag 24. After this backwashing procedure, the valve 12 in the unfiltered fluid channel 20 closes again, and the filter device is again ready to filter unfiltered fluid.

The valves 12 are activatable using a control fluid, in particular compressed air. The control fluid is introduced between the diaphragm 13 and the valve cover 14 with sufficient pressure that the diaphragm 13 is not lifted off from the valve seat 15 in normal operation. When the valve 12 is to be opened, the pressure of the control fluid is reduced and the diaphragm 13 thus lifts off from the valve seat 15.

A filter device according to FIG. 1 is schematically illustrated in FIG. 1a. The filter device comprises a container 18, in which a filter unit module 16a comprising four filter unit stacks 16 is situated. The filter unit module 16a has an unfiltered fluid connection 19, which may be opened and closed using a valve 12a. The unfiltered fluid connection 19 is connected to the unfiltered fluid channel 20′ of each filter unit stack 16. The filtered fluid channels 22′ of the filter unit stacks 16 are connected to a filtered fluid channel 22, with each filter unit stack 16 being able to be opened and closed using a separate valve 12c.

The filtered fluid channel 22 discharges on one hand into a collecting vessel 23 and on the other hand into a filtered fluid container 23′. The filtered fluid container 23′ can be shut off from the filtered fluid line 22 using a valve 12d. The unfiltered fluid connection 19 is connected to an unfiltered fluid container R, and a pump P is provided to force the fluid to be filtered into the filter unit module 16a. Furthermore, the unfiltered fluid connection 19 is connected to a concentrate drain 26, which discharges into a filter bag 24. The concentrate drain 26 may be opened and closed via a valve 12b.

The container 18 is provided with a drain line A which discharges into a further container 18′. The container 18′ is connected to an unfiltered fluid container R such that fluid collected in the container 18′ may be returned to the unfiltered fluid container R by opening the valve 12′.

A sensor S1 for detecting a minimum level status and a sensor S2 for detecting a maximum level status are provided for detecting the liquid level in the container 18′. As soon as the liquid level is detected by the sensor S2, the valve 12′ is opened. After the level falls below sensor S1, the valve 12′ is closed again.

The fluid to be filtered starts out in the unfiltered fluid container R. From there, it is pumped with valve 12a open through the unfiltered fluid connection 19 into the filter unit module 16a. In this state, the valve 12b is closed. At least one of the valves 12c is open, so that the filtered fluid may exit from the filter unit module 16a through the filtered fluid channel 22. The filtered fluid flows into the collecting vessel 23 or, with valve 12d open, into the filtered fluid container 23′, from where it is supplied for its further use.

If one or more of the filter unit stacks 16 becomes loaded with dirt, the valve 12d is closed and the respective valve 12c is opened so that the filter unit stack 16a may be backwashed. For this purpose, the valve 12a is also closed and the valve 12b into the concentrate drain 26 is opened. The contaminated backwashing fluid is collected in the filter bag 24. When the fluid contained in the filter unit module 16a may not be filtered further, the fluid is removed from the filter unit module via the concentrate drain 12b. When the bag 24 is full, it is replaced or emptied. The concentrate is then disposed of. Because the filter units of the filter unit stack 16 are only clamped against one another, slight leaks may occur. These are collected in the container 18 and removed from the container 18 via the drain line A.

A respective pressure switch D, which detects the pressure level in the particular channel, is situated both in the filtered fluid channel 22 and also in the unfiltered fluid channel 20.

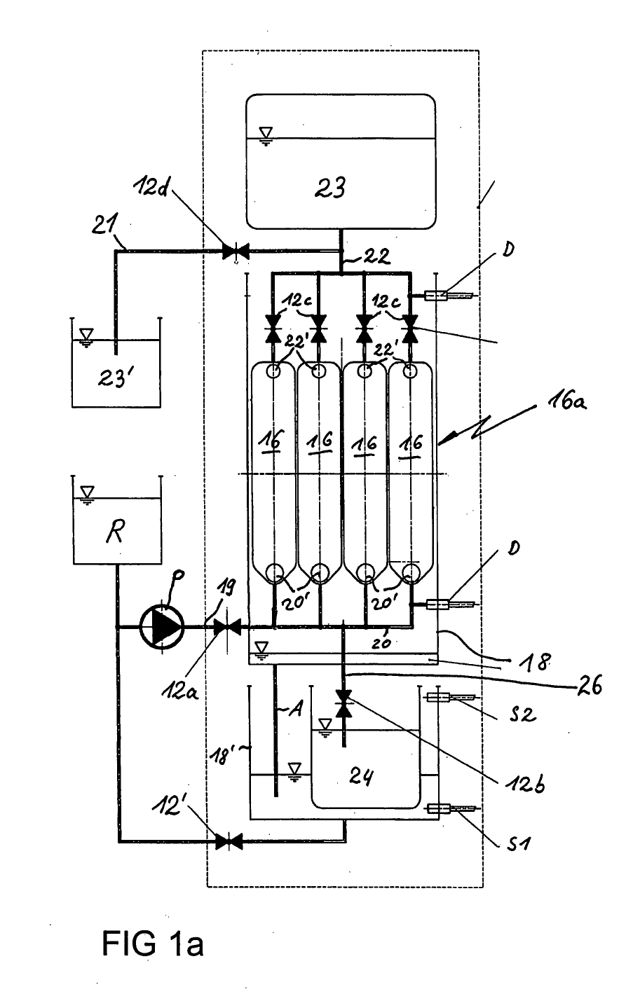

An adapter plate 11 is illustrated in a sectional view in FIG. 2. Components in FIG. 2 corresponding to those of FIG. 1 are identified by the same reference numerals. The unfiltered fluid channel 20 in the adapter plate 11 is represented by two holes extending diagonally downward toward the middle, with one hole being closed to the outside. The other hole forms an inlet 27, through which the fluid to be filtered is introduced into the adapter plate 11. The unfiltered fluid channel 20 has distributor holes 28, which are situated in such a way that they correspond to the filter unit stacks 16. Furthermore, the number of the distributor holes 28 is matched to the number of the filter unit stacks 16 so that each filter unit stack 16 has its own distributor hole. The valve seat 15 for the valve 12 provided in the unfiltered fluid channel 20 is situated in the middle, where the two holes meet.

The filtered fluid channel 22 also is formed by a bore hole, with a vertically extending bore hole meeting a horizontally extending bore hole. The filtered fluid exits again from the adapter plate 11 through the vertical hole. Openings 29, whose number corresponds to the number of filter unit stacks 16, are situated in the horizontally extending hole. A valve seat 15 for a valve 12 is situated in each of these openings 29. Furthermore, the horizontally extending hole is closed on its front sides in operation.

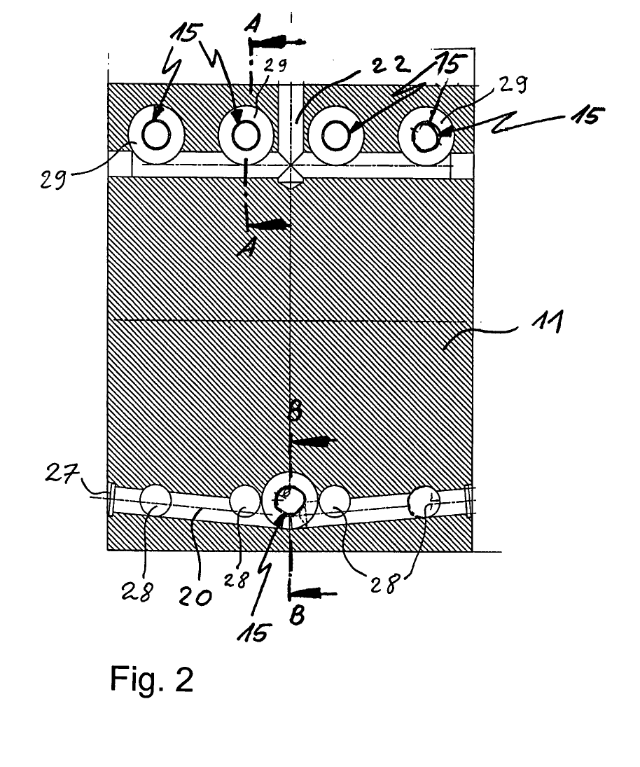

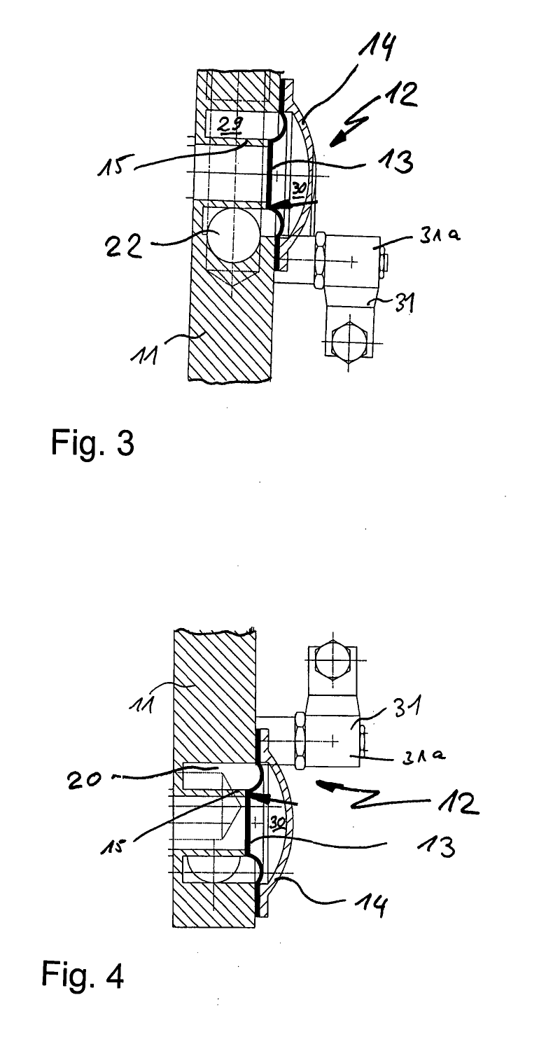

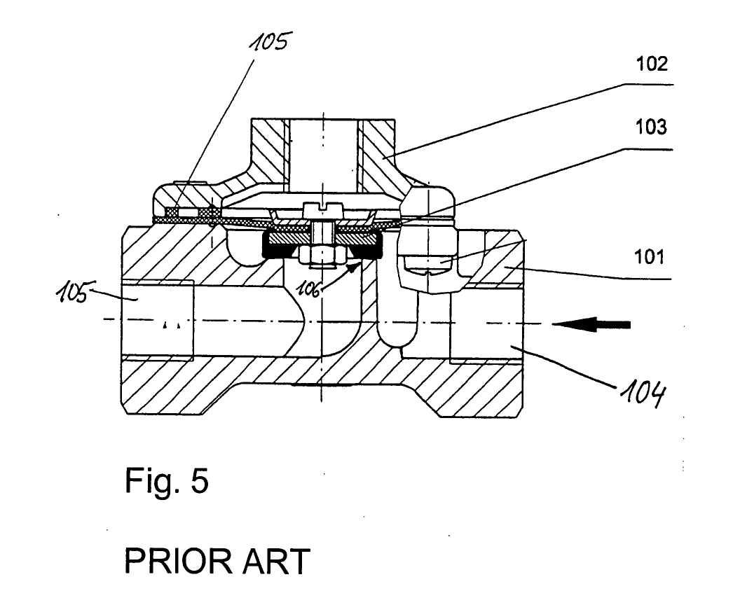

FIG. 3 shows a valve 12 in the filtered fluid channel 22 in a sectional view taken along line A-A of FIG. 2, and FIG. 4 shows a valve 12 in the unfiltered fluid channel 20 in a sectional view taken along line B-B of FIG. 2. The construction of the valves 12 is identical in both figures. Again, components corresponding to FIG. 1 or FIG. 2 are identified by the same reference numerals. The diaphragm 13 and the valve cover 14 are connected to one another and to the adapter plate 11 in a sealed manner.

A control chamber 30, which is connected via a solenoid valve 31a to a control fluid line 31, is formed between the diaphragm 13 and the valve cover 14. A control fluid may be introduced into the control chamber 30 through the control fluid line 31 using the solenoid valve 31a, such that the control pressure required in the control chamber 30 can be adapted to the particular operating state of the valve 12. When the valve 12 is closed or kept closed, a higher control pressure is necessary than when the valve 12 is opened.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A valve module for controlling a fluid flow, said valve module comprising a valve comprising a valve cover, a valve body, and a valve seat, wherein the valve body is configured to matingly correspond to the valve seat; the valve seat is integrated in an adapter plate; the valve body and the valve cover are attached to the adapter plate in a sealed manner to form a control chamber; and the adapter plate has an unfiltered fluid channel and a filtered fluid channel situated inside the adapter plate, an inlet leading to the unfiltered fluid channel, and an outlet leading from the filtered fluid channel.

2. A valve module according to claim 1, wherein the valve seat is press-fit into the adapter plate.

3. A The valve module according to claim 1, wherein the valve body is an elastic diaphragm.

4. A valve module according to claim 1, wherein the adapter plate is provided with a valve in the filtered fluid channel for closing the filtered fluid channel.

5. A valve module according to claim 1, wherein the adapter plate is provided with a valve in the unfiltered fluid channel for closing the unfiltered fluid channel.

6. A valve module according to claim 5, wherein the filtered fluid channel is provided with at least two valves arranged in parallel each of which closes or opens a separate channel independently of one another.

7. A filter device for filtering a fluid comprising a container, an unfiltered fluid connection, and a filtered fluid connection, and at least one filter unit stack situated in the container, wherein each filter unit stack is connected to a valve module according to claim 1 such that each filter unit stack is activatable individually by the respective valve module to which it is connected.
